(19) United States
(12) Patent Application Publication
(10) Pub. No.: US 2010/0080969 A1
(43) Pub. Date: Apr. 1, 2010

(54) METHOD FOR METALLIZING A COMPONENT

(76) Inventors: Jacob Koenen, Sittard (NL); Luc Elza Florent Leemans, Kortessem (BE)

Correspondence Address: NIXON & VANDERHYE, PC, 901 NORTH GLEBE ROAD, 11TH FLOOR, ARLINGTON, VA, 22203, US

(21) Appl. No.: 12/441,578

(22) PCT Filed: Sep. 25, 2007
(86) PCT No.: PCT/EP07/08318

§ 371 Date: Nov. 4, 2009

(30) Foreign Application Priority Data
Sep. 26, 2006 (EP) 06020115.9

(51) Int. Cl. B32B 3/10; B05D 5/00; B32B 15/08; C23C 18/20

(52) U.S. Cl. 428/209; 427/256; 428/458

(57) ABSTRACT

The invention relates to a method for metallizing a component comprising a first part constituted of a polyester comprising thermoplastic composition first material, and a second part constituted by a polyamide comprising thermoplastic composition, wherein a metallizing seed layer is applied, the component is exposed to an discriminating etching liquid, and thereafter exposed to a metallizing environment The invention also relates to a metallized component obtainable by said method.

The invention relates to a method for selectively metallizing a component comprising a first part, made of a first material, and a second part, made of a second material. The invention also relates to a metallized component.

Components may comprise two or more component parts made from different materials. Such multi-material components may be fit for selective or partial metallizing. Several different methods for selective metallization are known, like selective surface conditioning, the use of pre-catalyzed polymers, laser activation or lithographic techniques etc.

More particular, the invention relates to a method for preparing a selectively metallizable component comprising sequential steps, wherein a metallizing seed layer is applied on at least part of the surface of said first part and on at least part of the surface of said second part, and the said parts of the surfaces of the first and second parts, including the metallizing seed layer, are exposed to a discriminative etching liquid, in which the first material is soluble and in which the second material is not soluble. For the metallization itself the said steps, by which the selectively metallizable component is prepared, are followed by a step wherein at least the said parts of the surfaces of the first and second parts of the selectively metallizable component are exposed to a metallizing environment.

One such a method is known from EP-1524331-A1. This method comprises the metallizing of a component that is constituted by a first part, made of a first material, and a second part, made of a second material. The first material may be a first polymer or other plastic, the second material a second polymer or plastic. Also other kinds of non-conductors, like e.g. ceramics, may be applied as first and/or second material. The known method of EP-1524331-A1 is based on the use of different (e.g. polymeric or ceramic) materials having different chemical solubility in or resistance towards particular solvents. The known method comprises the following sequential steps: a metallizing seed layer, e.g. catalytic to the subsequent chemical metallization process, is applied at the surface of the component, after which the surface of the component, including the metallizing seed layer, is exposed to a solvent in which the surface of the first part is, and the surface of the second part is not soluble. In a following step the surface of the component is exposed to a metallizing environment that, however, will only be metallized on the surface of the second component part. At least this is the objective. According to EP-1524331-A1 a metallizing seed layer, which may be catalytic to the further metallization process, is applied at the surface of said component or a relevant part of that component's surface, after which the surface of the whole component or at least the relevant part of it, including said seed layer, is exposed to a “discriminating” solvent in which the surface material of said first part is soluble but the surface material of said second part is not. After the surface has been exposed to a solvent in which the first part is and the second part is not soluble, the first part's surface, including its seed layer, will be solved in the solvent and eliminated. The metallizing seed layer thus will only stay at the surface of the second component part, which was made of a material, not soluble in (well resistant to) the used solvent. After a subsequent exposure of the (complete) component to a metallizing environment, only that component part, the second part, on which the metallizing seed layer was left after exposure of the “discriminating” solvent, will be metallized, due to the presence of the remaining seed layer at the second component part and the absence of it at the first part.

Many polymers with different solubilities towards different solvents are listed in EP-1524331-A1. As an example of a suitable polymer combination, the combination PC/ABS is mentioned. A sodium hydroxide solution is used as discriminating solvent, which is reported in EP-1524331-A1 to result in a “nearly 100% selective” metallization of the ABS component. If the metallization is not 100% selective, the metallization not only results in metal deposition on one of the first and second material, but to a certain extent also on the other material.

A problem with the method of EP-1524331-A1 is that for various applications the selectivity of the metallization is not good enough. In particular in E&E segments with a trend of to miniaturization and downsizing in dimensions, a very high selectivity is required. If the selectivity is not high enough this can lead to short circuitry problems. Another problem of the ABS/PC system is that metallization of components with this combination of materials is still rather sensitive for the adjustment of the composition of the metallization environment that is used for the metallization step. A further problem of the ABS/PC system is that the adhesion of the metal layer to the polymer is low, which can be a cause for damages during further handling and processing of the component.

The primary aim of the present invention is to provide a method, as well as a component, which does not have these problems, or in lesser extent, and which results in a higher selectivity in the metallization process and/or reduced sensitive of the metallization selectivity for the adjustment of the composition of the metallization environment. A second aim of the invention is to provide a component comprising a part covered with a metal layer that has improved adhesion.

This aim has been achieved with the process according to the invention, wherein one of the first material and second material is a polyester comprising thermoplastic composition and the other of the first material and the second material is a polyamide comprising thermoplastic composition.

The effect of method according to the invention wherein the said combination of a polyamide comprising thermoplastic composition and a polyester comprising thermoplastic composition as the first and second material is used, is that the selectivity in the metallization process is enhanced. This effect can be observed visibly or by microscopy in that less-to-no metal is deposited on the first material and/or that the absence of metal deposition on the first material is less sensitive for the adjustment of the composition of the metallization environment. In other words the inventive method is much more robust towards variation in the composition of the metallization environment.

With the term thermoplastic composition is herein understood a compositions comprising or consisting of a thermoplastic polymer. With the term polyester, or polyamide, comprising thermoplastic composition is herein understood a thermoplastic composition, wherein the thermoplastic polymer comprises or consists of a thermoplastic polyester, respectively a thermoplastic polyamide.

With the term “etching liquid” is herein understood a liquid, which can be a solvent, or mixture of solvents, and/or a solution of one or more etching agents in a solvent or solvent mixture, which can etch the surface of a part constituent of a polymeric material, either through dissolution of at least part of the polymeric material, or through chemical degradation of at least part of the polymeric material. Through the action of etching a surface layer of the part is removed.

With the expression “in which (etching liquid) the first material is at soluble” is herein understood the effect which can be obtained with the etching liquid, i.e. that a surface layer of a part made from said first material can be removed through exposure of the part to the etching liquid, independent of whether this result is obtained through dissolution or through chemical degradation of at least part of the said polymeric material.

In the method according to the invention, the metallizing seed layer can be applied by any method that is suitable for that purpose. For the metal that is used in the seed layer preferably a metal is used that is a catalysts for electroless deposition process. Suitably, the metallizing seed layer is applied by deposition of Pd and/or Sn nuclei. Also suitably for applying the metallizing seed layer a colloidal solution or a ionic solution is used, by which a colloidal metallizing seed layer or an ionic metallizing seed layer is formed. Preferably the metallizing seed layer is a colloidal metallizing seed layer comprising Pd-nuclei.

The etching liquid that is used in the method according to the invention, may be any etching liquid, that is a ‘discriminatory etching liquid” for polyester comprising thermoplastic compositions and polyamide comprising thermoplastic compositions, i.e. an etching liquid in which one of these materials is soluble and in which the other material is not soluble.

Suitable etching liquids that can be used in the method according to the invention include acidic solutions, alkaline solutions and organic solvents.

Acidic solutions are preferred to etch the surface of the part constituted of the polyamide material. Examples of suitable acidic solutions are diluted aqueous solutions of hydrochloric acid, acetic acid, trifluoroacetic acid, nitric acid, sulfuric acid, hydrofluoroacid. Preferably, the acidic solution has a pH in the range of 0-6, more preferably 1-4.

Alkaline solutions and preferred to etch the surface of the part constituted of the polyester material. Examples of suitable alkaline solutions are aqueous solutions of sodium hydroxide, potassium hydroxide, and lithium hydroxide, and mixtures thereof. Preferably, the alkaline solution has a pH in the range of 8-14, more preferably 10-13. A suitable commercially available alkaline etching liquid is Enplate MID Select Etch 9020.

Organic solvents can be chosen to preferably etch either the surface of the part constituted of the polyamide material or the surface of the part constituted of the polyester material. For example, chlorobenzene can be used as an etching liquid for polyamide material, whereas chlorinated aliphatic hydrocarbons, such as methylene chloride, chloroform, thrichoroethane, and tetrachloroethane, can be used as an etching liquid for polyester material.

Preferably the etching liquid is an alkaline solution. The advantage of the use of an alkaline solution in the method according to the invention is that the selectivity for metallization is further enhanced.

It is noted that the present inventive method, using polyester and polyamide materials in combination with a discriminating etching liquid, may be used in combination with a known method where for example an adsorbent is used with different adsorbing properties for the two materials, of which part 1 and part 2 are made. Such an adsorbent is herein also denoted as discriminating adsorbent. Such a discriminating adsorbent is advantageously used when forming the metallizing seed layer. The use of a discriminating etching liquid according to the method of the invention in combination with a discriminating adsorbent for forming the metallizing seed layer mutually enforce each other and enhance the final result.

For preparing a component as described above, wherein the second component part is selectively covered by a metallic layer, the steps in the method according to the invention are followed by a step wherein the said parts of the surfaces of the first and second parts are exposed to a metallizing environment. Exposure of the component to the metallizing environment may be performed either completely or only partially, for example at least the said parts of the surfaces of the first and second parts are exposed to the metallizing environment. After this subsequent exposure of the component to the metallizing environment, only one part will be metallized, i.e. a metal layer or metal coating is formed on at least part of the surface of the second part. The result of the final metallizing process is a component, wherein only the second component part is covered by a metal layer, due to the presence of the seed layer which was left after exposure to the “discriminating” etching liquid, while the other part remains un-covered, due to the absence of the metallizing seed layer, which was solved by the “discriminating” etching liquid.

For the exposure to a metallizing environment, any metallizing environment that is suitable for metallizing components bearing a metallizing seed layer may be used. Suitably, the metallization step is based on catalytic reduction of a metal coating (e.g. Cu or Ni) applied upon the seed layer from a solution comprising both the relevant coating metal ions and a reduction chemical.

In a preferred embodiment the metal layer is a nickel-phosphor layer applied on a polyester material as the second material. The advantage is the adhesion between the metal layer and the second material is further enhanced.

In a more preferred embodiment the metal layer is a copper layer applied on a polyamide material as the second material. The advantage is that the adhesion between the metal layer and the second material is still further enhanced.

The metallization step may suitably be performed in combination with a colloidal metallizing seed layer or a liquid crystalline seed layer.

In the method according to the invention, the polyester composition comprises a thermoplastic polyester.

With the term “thermoplastic polyester” is herein understood a polymer consisting essentially of residual structural elements of diacids and diols, as represented by formula I:

HO—[—{—C(O)—R1—C(O)—}—{O—R2—O—}—]ₙ—H (I)

wherein —C(O)—R1—C(O)— denotes a residual structural element of a dicarboxylic acid and —O—R2—O— denotes a residual structural element of a diol.

Such polyesters can be prepared by polycondensation of diacids, or ester derivatives thereof, and diols, using processes well known in the art. Next to the diacids, or ester derivatives thereof, and diols, optionally small amounts of other components, including monofunctional and trifunctional alcohols and carboxylic acids, can be used during the polycondensation, and residual structural elements thereof can be present in the thermoplastic polymer, provided that these polyesters remain melt processable.

The thermoplastic polyester that is used in the composition according to the invention, suitably is an amorphous polyester or a semi-crystalline polyester, and preferably is a semi-crystalline polyester with a melting temperature (Tm) of at least 200° C. More preferably the thermoplastic polyester polymer is a semi-crystalline semi-aromatic polyester. Said semi-crystalline semi-aromatic polyester is generally derived from at least one aromatic dicarboxylic acid or an ester-forming derivative thereof, and at least one alkylene diols and/or aromatic diol, and includes homo- as well as copolymers. Such a semi-aromatic polyester is represented by formula I, wherein R1 represents an aromatic group and wherein R2 represents an alkylene or an aromatic group. Suitably, the semi-crystalline semi-aromatic polyester is a liquid crystalline polyester.

Examples of suitable aromatic diacids include terephthalic acid, isophthalic acid, naphthalene dicarboxylic acid, biphenyl dicarboxylic acid, etc., with terephthalic acid being preferred. Suitable alkylene diols include both aliphatic diols and (cyclo)aliphatic for diols. Suitable aromatic diols are, for example, hydroquinone, dihydroxyphenyl, naphthalene diol. Alkylene diols, like ethylene diol, propylene diol, 1,4-butylene diol or butane diol, neopentyldiol, and cyclohexane dimethanol are preferred.

These semi-aromatic polyester may further comprise small amounts of, for example, aliphatic dicarboxylic acids, mono functional alcohols and/or carboxylic acids and three or higher functional alcohols and/or carboxylic acids. Preferably, the content of other components in these polyesters is below 20 wt. %, below 10 wt. %, more preferably below 5 wt. %, relative to the total weight of the polyester, to ensure the semi-crystallinity of the polyester.

More preferably, the thermoplastic polyester in the component used in the method according to the invention is a semi-aromatic polyester consisting of residual structural elements of diacids, diols and optionally small amounts of mono- and/or trifunctional components, wherein the residual structural elements of the diacids are derived for at least 90 wt. %, relative to the total weight of the residual structural elements of the diacids, of aromatic diacids and the residual structural elements of the diols are derived for at least 90 wt. %, relative to the total weight of the residual structural elements of the diols, of short chain alkylene diols with 2-6 C-atoms.

Suitable semi-aromatic thermoplastic polyester polymers that can be used in the composition according to the invention are, for example, polyalkyleneterephthalates, polyalkylene naphthalates, and polyalkylene bisbenzoates and any copolymers and any mixtures thereof. These polyesters can be derived from alkylene diols and, respectively terephthalic acid, naphthalene dicarboxylic acid and 4,4′-diphenyldicarboxylic acid.

Suitably, the polyalkyleneterephthalate is poly(1,4-cyclohexane-dimethylene terephthalate) (PCT) or a poly(alkylene terephthalate) based on an aliphatic diol with 2 to 6 carbon atoms, like polyethyleneterephthalate (PET), polytrimethyleneterephthalate (PTT), and poly(1,4-butylene terephthalate) or simply called polybutylene terephthalate (PBT).

Suitable poly(alkylene naphthalate)s include polyethylenenaphthalate (PEN) and polybutylenenaphthalate (PBN). Suitable polyalkylene bisbenzoates include polyethylenebisbenzoate (PEBB) and polybutylenebisbenzoate (PBBB). Suitably, these semi-aromatic thermoplastic polyester polymers comprise a minority content of another dicarboxylic acid or diol.

Of these polyesters, PET, PTT, PBT, PEN, PTN, PBN, and any mixture or copolymer thereof are preferred. More preferably the thermoplastic polyester polymer comprises PET or even consists essentially or even completely of PET, since PET provides an optimal combination of heat distortion properties and selectivity in etching and metallization.

In the method according to the invention, the polyamide composition comprises a thermoplastic polyamide.

With the term “thermoplastic polyamide” is herein understood a polymer consisting essentially of residual structural elements of diacids and diamines, and/or amino-acids.

Such polyamides can be prepared by polycondensation of diacids, or ester derivatives thereof, and diamines, and/or amino-acids and/or lactam derivatives thereof, using processes well known in the art. Next to the diacids, or ester derivatives thereof, diamines, and amino-acids, or lactam derivatives thereof, optionally small amounts of other components, including monofunctional and trifunctional amines and carboxylic acids, can be used during the polycondensation, and residual structural elements thereof can be present in the thermoplastic polyamide, provided that these polyamides remain melt processable.

Suitable thermoplastic polyamides that can be used in the polyamide composition are, for example, aliphatic polyamides, semi-aromatic polyamides and mixtures thereof. Also suitably the thermoplastic polyamide is an amorphous polyamide or a semi-crystalline polyamide.

Suitable aliphatic polyamides are, for example, PA-6, PA-11, PA-12, PA-4,6, PA-4,8, PA-4, 10, PA-4, 12, PA-6,6, PA-6,9, PA-6,10, PA-6,12, PA-10,10, PA-12,12, PA-6/6,6-copolyamide, PA-6/12-copolyamide, PA-6/11-copolyamide, PA-6,6/11-copolyamide, PA-6,6/12-copolyamide, PA-6/6,10-copolyamide, PA-6,616,10-copolyamide, PA-4,6/6-copolyamide, PA-6/6,6/6,10-terpolyamide, and copolyamides obtained from 1,4-cyclohexanedicarboxylic acid and 2,2,4- and 2,4,4-trimethylhexamethylenediamine, and copolyamides of the aforementioned polyamides.

Suitable semi-aromatic polyamides are, for example, PA-6,I, PA-6,I/6,6-copolyamide, PA-6,T, PA-6,T/6-copolyamide, PA-6,T/6,6-copolyamide, PA-6,I/6, T-copolyamide, PA-6,6/6,T/6,I-copolyamide, PA-6,T/2-MPMD,T-copolyamide (2-MPMD=2-methylpentamethylene diamine), PA-9,T, PA-9T/2-MOMD,T (2-MOMD=2-methyl-1,8-octamethylenediamine), copolyamides obtained from terephthalic acid, 2,2,4- and 2,4,4-trimethylhexamethylenediamine, copolyamide obtained from isophthalic acid, laurinlactam and 3,5-dimethyl-4,4-diamino-dicyclohexylmethane, copolyamides obtained from isophthalic acid, azelaic acid and/or sebacic acid and 4,4-diaminodicyclohexylmethane, copolyamides obtained from caprolactam, isophthalic acid and/or terephthalic acid and 4,4-diaminodicyclohexylmethane, copolyamides obtained from caprolactam, isophthalic acid and/or terephthalic acid and isophoronediamine, copolyamides obtained from isophthalic acid and/or terephthalic acid and/or other aromatic or aliphatic dicarboxylic acids, optionally alkyl-substituted hexamethylenediamine and alkyl-substituted 4,4-diaminodicyclohexylamine, and copolyamides of the aforementioned polyamides.

Preferably thermoplastic polyamides are chosen from the group consisting of PA-6,6, PA-4,6, PA-6,T, PA-6,I/6,T-copolyamide, PA-6,T/6,6-copolyamide, PA-6,T/6-copolyamide, PA-6/6,6-copolyamide, PA-6,6/6,T/6,I-copolyamide, PA-6,T/2-MPMD,T-copolyamide, PA-9,T, PA-9T/2-MOMD,T-copolyamide, PA-4,6/6-copolyamide and mixtures and copolyamides of the aforementioned polyamides.

Preferably, the thermoplastic polyamide is an amorphous polyamide having a glass transition temperature (Tg) of at least 200° C. or a semi-crystalline polyamide having a melting temperature (Tm) of at least 200° C.

More preferably, the Tg or Tm is at least 220° C., 250° C., or even at least 280° C. The advantage of a higher Tg or Tm for the thermoplastic polyamide is that the component obtained by the method according to the invention has a very good performance in an SMT (surface mounting technology) process

More preferably, the thermoplastic polyamide is a semi-crystalline polyamide having a melting temperature (Tm) of at least 280° C.

The first and/or second material in the component that is used in the method according to the invention may comprise, next to the thermoplastic polyester, respectively the thermoplastic polyamide, other constituents. These other constituents may be any constituent that is suitable for use in polymeric compositions.

Suitable constituents include other thermoplastic components, fillers (e.g. inorganic fillers) and fibrous reinforcing materials (e.g. glass fibres) and other additives. Such additive may comprise any additive known to a person skilled in the art that are customarily used in polymer compositions. Suitable additives include pigments, processing aids, (for example mould release agents, nucleating agents or agents accelerating crystallization), stabilizers (e.g. UV stabilizers and antioxidants), flame-retardants, impact modifiers and compatibilizers. Suitable as inorganic filler are all the non-metallic and non-fibrous, inorganic fillers known to a person skilled in the art, for example glass beads, aluminium silicates, mica, clay, calcined clay and talcum.

The first and/or second material compositions that are used in the component in the method according to the invention suitably are filled and/or fibre reinforced materials, comprising, respectively, a filler and/or fibrous reinforcing material.

In a preferred embodiment, the first and/or second material consist of
a) 30-90 wt. % of thermoplastic polymer,
b) 10-60 wt. % filler and/or fibrous reinforcing material, and
c) and 0-20 wt. % of other additives,
   wherein the wt. % of a), b) and c) are relative to the total weight of the material and the sum of a), b) and c) is 100%.

More preferably, the first and/or second material consist
a) 40-85 wt. % of thermoplastic polymer,
b) 15-55 wt. % filler and/or fibrous reinforcing material, and
c) and 0-10 wt. % of other additives.

Also more preferably, the thermoplastic polymer consists for at least 75 wt. %, still more preferably at least 80 wt. % or even 90 wt. %, relatively to the weight of the thermoplastic polymer, of the thermoplastic polyester, respectively the thermoplastic polyamide.

The invention also relates to a component comprising a first part constituted of a first material, and a second part constituted of a second material, the second part comprising a metallizing seed layer, and more particular to a component wherein the metallizing seed layer is covered by a metallic layer.

In the component according to the invention, one of the first and the second material is a polyester comprising thermoplastic composition and the other of the first and the second material is a polyamide comprising thermoplastic composition.

The component according to the invention suitably is a component, obtainable with the method according to the invention described herein above, or any preferred embodiment thereof.

The invention is further illustrated with the following examples and comparative experiments.

### EXAMPLE I

A 2-K injection moulded component comprising a polyester part and a polyamide part, was prepared from a glass fibre PET material (composition: PET 64 wt. %, glass fibres 35 wt. %, auxiliary additives 1 wt. %) and a glass fibre reinforced Polyamide-4,6 material (composition: Polyamide-4,6 69 wt. %, glass fibres 30 wt. %, auxiliary additives 1 wt. %). After a Pd nuclei containing colloidal metallizing seed layer was applied onto the component, the component was exposed for 5 minutes at 40° C. to an alkaline etching solution containing diluted sodium hydroxide solution, rinsed with water, and finally subjected to a copper containing metallizing environment. The resulting component was inspected visually and by light microscopy and showed a metallic layer of copper on the Polyamide part and hardly any metal on the PET material.

### Comparative Experiment A

Example I was repeated except that part was PET material and the Polyamide-4,6 material were replaced by a Polycarbonate material and an ABS material, respectively. The resulting component showed more metal on the polycarbonate material.

### Adhesion Test

The adhesion of the metal layer on the second part of each of the components of Example I and Comparative Experiment A were determined qualitatively by adhering a test element to the metal layer and pulling on the test element. The adhesion showed to be much better in the case of the Polyamide-4,6 material of Example I than in the case of the ABS material of Comparative Experiment A.

1. Method for metallizing a component comprising a first part, constituted by a first material and having a first surface, and a second part, constituted by a second material and having a second surface, the method comprising next sequential steps:
a metallizing seed layer is applied on at least part of the surface of said first part and on at least part of the surface of said second part, and
the said parts of the surfaces of the first and second parts including the metallizing seed layer, are exposed to an etching liquid, in which the first material is soluble and in which the second material is not soluble, characterized in that the one of the first material and second material is a polyester comprising thermoplastic composition and the other of the first material and the second material is a polyamide comprising thermoplastic composition.

2. Method according to claim 1, wherein the metallizing seed layer is applied by deposition of metal seeds comprising Pd nuclei.

3. Method according to claim 1, wherein the etching liquid is an alkaline solution.

4. Method according to claim 1, followed by a step wherein the said parts of the surfaces of the first and second parts are exposed to a metallizing environment, thereby forming a metal layer on at least part of the surface of the second part.

5. Method according to claim 4, wherein the metallization is performed with copper or nickel.

6. Method according to claim 1, wherein the polyester comprising thermoplastic composition comprises a semi-crystalline thermoplastic polyester.

7. Method according to claim 1, wherein the polyamide comprising thermoplastic composition comprises a semi-crystalline polyamide.

8. Method according to claim 1, wherein the first and/or second material is a filled and/or fibre reinforced material.

9. Component comprising a first part, constituted of a first material, and a second part, constituted of a second material and comprising a metallizing seed layer, wherein one of the first material and second material is a polyester comprising thermoplastic composition and the other of the first material and the second material is a polyamide comprising thermoplastic composition.

10. Component comprising a first part, constituted of a first material and having a non-metallized surface, and a second part, constituted of a second material and having an at least partially metallized surface, wherein one of the first material and second material is a polyester comprising thermoplastic composition and the other of the first material and the second material is a polyamide comprising thermoplastic composition.

11. A partially metallized component obtainable by the method according to claim 1.
